(19) United States
(12) Patent Application Publication
(10) Pub. No.: US 2024/0112410 A1
(43) Pub. Date: Apr. 4, 2024

(54) LEARNED FEATURE PRIORITIZATION TO REDUCE IMAGE DISPLAY NOISE

(71) Applicant: INTERNATIONAL BUSINESS MACHINES CORPORATION, Armonk, NY (US)

(72) Inventors: Xiao Xia Mao, Shanghai (CN); Meng Ran Chen, Shanghai (CN); Ya Qing Chen, Shanghai (CN); Yan An, Shanghai (CN); Yin Hu, Ningbo (CN)

(21) Appl. No.: 17/955,977

(22) Filed: Sep. 29, 2022

(51) Int. Cl. G06T 19/00; G06F 40/20; G06T 5/00; G06T 19/20; G06V 10/74

(52) U.S. Cl. CPC G06T 19/003; G06F 40/20; G06T 5/002; G06T 5/005; G06T 19/20; G06V 10/761; G06T 2200/24; G06T 2207/20081

(57) ABSTRACT

Systems and methods enable machine learning (ML) feature prioritization to reduce image noise in a virtual environment. In embodiments, a method includes providing a device access to a virtual environment via a graphical user interface (GUI), the environment including images of objects and a navigation tool enabling a user to navigate the environment and interact with the images; monitoring interaction data of the user; calculating priority values for predefined areas of a first object in the environment, using an ML model trained with historic user interaction data and object data; processing image data of one or more of the predefined areas of the first object using image processing to generate new data based on display specifications of the client device and the priority values; and pre-loading the new data in a buffer, such that the new data is available prior to display of the new data to the user.

### BACKGROUND

Aspects of the present invention relate generally to digital image displays and, more particularly, to optimizing the display of digital images using artificial intelligence (AI) feature prioritization.

Virtual environments enabling remote users to view digital images or videos of real objects are on the rise. One such virtual environment is a virtual gallery or museum in which remote users can interact with digital images of works of art via a graphic user interface (GUI).

A moiré effect or moiré pattern is a visual perception that occurs when viewing a set of lines or dots that is superimposed on another set of lines or dots, where the sets differ in relative size, angle or spacing. For the moiré interference pattern to appear, the two patterns must not be completely identical, but are displaced, rotated, or have a slightly different pitch. A moiré pattern may display as odd stripes or irregular ripples appearing on a display screen. With respect to light emitting diode (LED) displays, the moiré effect may occur from a pixel structure of an LED board of the display conflicting with a pixel structure of an image (photograph or video) displayed thereon. Various methods for addressing moiré patterns in images have been developed.

### SUMMARY

In a first aspect of the invention, there is a computer-implemented method including: providing a client device access, by a computing device, to a virtual environment via a graphical user interface (GUI), the virtual environment including images of objects and a user navigation tool enabling a user to navigate the virtual environment and interact with the images of the objects; monitoring and recording, by the computing device, real-time interaction data of the user indicating navigation of the user through the virtual environment and interactions of the user with the images; calculating, by the computing device, priority values for predefined areas of a first object of the objects in the virtual environment, using a machine learning (ML) model trained with historic user interaction data and object data; processing, by the computing device, digital image data of one or more of the predefined areas of the first object using image processing to generate new digital image data based on display specifications of the client device and the priority values; and pre-loading, by the computing device, the new digital image data in a buffer, such that the new digital image data is available to the computing device prior to display of the new digital image data to the user via the GUI.

In another aspect of the invention, there is a computer program product including one or more computer readable storage media having program instructions collectively stored on the one or more computer readable storage media. The program instructions are executable to: provide a remote client device access to a virtual environment via a graphical user interface (GUI), the virtual environment including images of artworks and at least one user navigation tool enabling a user to navigate the virtual environment and interact with the images of the artworks; monitor and record real-time interaction data of the user indicating navigation of the user through the virtual environment and interactions of the user with the images; determine a user category type of the user; determine display specifications of the client device; calculate priority values for predefined features of a first artwork in the virtual environment based on the user category type of the user, using a machine learning (ML) model trained with historic user interaction data and data about the first artwork; process digital image data of one or more of the predefined features of the first artwork using image processing to generate new digital image data based on the display specifications of the client device and the priority values; and pre-load the new digital image data in a buffer, such that the new digital image data is available prior to display of the new digital image data to the user via the GUI.

In another aspect of the invention, there is system including a processor set, one or more computer readable storage media, and program instructions collectively stored on the one or more computer readable storage media. The program instructions executable to: provide a remote client device access to a virtual environment via a graphical user interface (GUI), the virtual environment including images of artworks and at least one user navigation tool enabling a user to navigate the virtual environment and interact with the images of the artworks; monitor and record real-time interaction data of the user indicating navigation of the user through the virtual environment and interactions of the user with the images; determine a user category type of the user; determine specifications of a display screen of the client device; calculate priority values for predefined features of a first artwork in the virtual environment based on the user category type of the user, using a machine learning (ML) model trained with historic user interaction data and data about the first artwork; process digital image data of one or more of the predefined features of the first artwork using image processing to generate new digital image data having a higher viewing quality on the display of the client device than the digital image data, based on the display specifications of the client device and the priority values; pre-load the new digital image data in a buffer; and display an image of the first artwork on the display screen of the client device via the GUI based on the pre-loaded new digital image data.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 depicts an overview of a feature prioritization process in accordance with aspects of the invention.

FIGS. 4A and 4B show a flowchart of an exemplary method in accordance with aspects of the invention.

FIG. 5 shows a data flow diagram in accordance with aspects of the invention.

### DETAILED DESCRIPTION

Aspects of the present invention relate generally to digital image displays and, more particularly, to optimizing the display of digital images using artificial intelligence (AI) feature prioritization.

In embodiments, a system utilizes machine learning (ML) to prioritize features of objects dynamically and selectively in a virtual environment, in order to pre-process and load image data of priority features to a buffer in anticipation of a particular user viewing the priority features. Implementations of the system address the technical problem of unclear or low quality image display in a virtual environment utilizing a trained predictive ML model. In aspects of the invention, input parameters to the trained predictive ML model include: screen specification data of a client device of the user; data regarding travel routes or tour routes within the virtual environment (e.g., derived from an exhibition guide); location and perspective data of the user within the virtual environment; data regarding features of the objects (e.g., artworks); and data regarding a type or category of the user. In implementations, the trained predictive ML model utilizes collaborative filtering techniques to generate predictions.

Websites enabling users to participate in virtual activities are on the rise, including museum shows, exhibitions, gallery shows, etc. When images of an artwork are displayed on an electronic screen, some visual display problems (visual noise) may occur that detract from the user experience. Visual noise may be particularly impactful on professional artists or art students wishing to closely examine a piece of art. One potential display issue is a moiré effect or moiré pattern, which can occur in a two dimensional or three-dimensional environment, and largely damages a user's digital image viewing experience.

Embodiments of the invention constitute an improvement in the field of digital image displaying, and address the problem of moiré patterns and other noise in image displays using machine learning (ML) image feature prioritization. Advantageously, embodiments of the invention improve the visual display of artworks for virtual environments, and take into consideration different artistic styles of objects or exhibits, and audience engagement.

In embodiments, a method is provided to improve the visual display of objects for virtual museums, comprising: based on following audience engagement behaviors, predicting potential visual display improvement areas of an object (e.g., work of art) for users/clients; viewing and monitoring a user's path within a virtual museum; viewing a user's interactions with the object (e.g., zoom-in, zoom-out, stay focused, etc.); determining attributes of a computing device of the user (e.g., supported resolution of a client device); predicting potential visual display improvement areas for users/clients, with consideration of the art style and noted features of the artwork by: determining viewing habits of amateur or professional audience groups and personal viewing preferences; collecting information from: literature in a database, analysis of the object/artwork itself, and descriptions in exhibition guides; and determining suggested viewing points based on the professional or official museum or artwork guides, features of the artwork including aesthetic values, influence of the artwork, and the originating artists' background and characteristics. In implementations, data from three sources of information about an artwork is used to predict potential visual display improvement areas for professional visitors, while data from an exhibition guide is used to predict the potential visual display improvement areas for amateur visitors. In embodiments, the potential visual display improvement areas are prioritized, and based on the prioritization, digital images of the areas are pre-processed to reduce display noise (e.g., moiré patterns) and are loaded in a buffer in advance of a user viewing the digital images.

It should be understood that, to the extent implementations of the invention collect, store, or employ personal information provided by, or obtained from, individuals (for example, user interact data or user login data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Learned Image Feature Prioritization 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

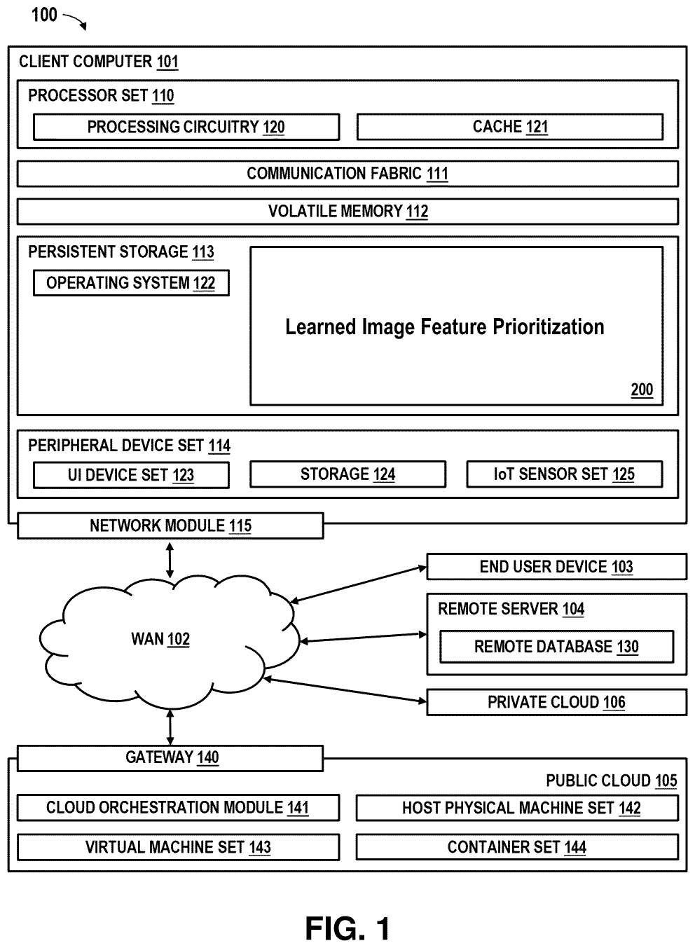

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101.

Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

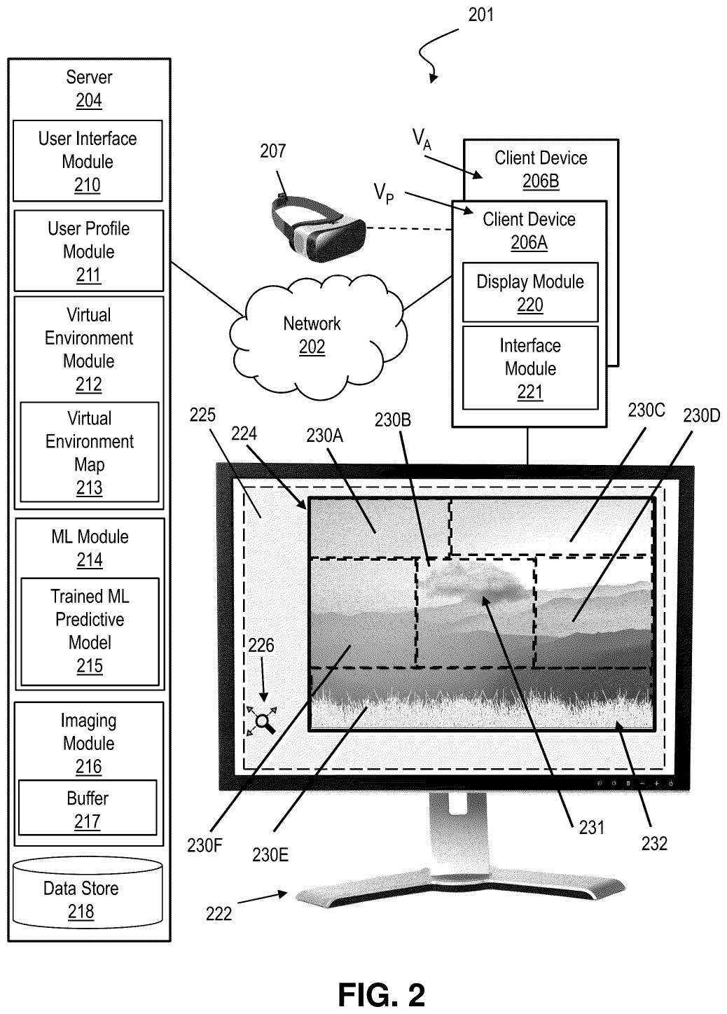

FIG. 2 shows a block diagram of an exemplary environment 201 in accordance with aspects of the invention. The environment 201 may be located within the computing environment 100 of FIG. 1. In embodiments, the environment 201 includes a network 202 (e.g., WAN 102 of FIG. 1) enabling communication between a server 204 and one or more client devices, represented by 206A and 206B. Peripheral or secondary devices, such as a virtual reality headset 207, may be utilized in conjunction with the client devices 206A and 206B.

The server 204 may comprise an instance of the computer 101 of FIG. 1, or elements thereof, and may be used alone or as part of a network of computing devices. In embodiments, the server 204 of FIG. 2 comprises software code (e.g., block 200 of FIG. 1) comprised of one or more modules. In implementations, these modules of the code of block 200 are executable by the processing circuitry 120 of FIG. 1 to perform the inventive methods as described herein. In the example of FIG. 2, the server 204 includes: a user interface module 210, a user profile module 211, a virtual environment module 212 associated with a virtual environment map 213, a machine learning (ML) module 214 associated with a trained ML predictive model 215, and an imaging module 216 associated with a buffer 217. In implementations, the server 204 may access data in a data store 218, including historic user interaction data for at least one virtual environment.

The client devices 206A and 206B may each comprise an instance of the user device 103 of FIG. 1, and may be used alone or as part of a network of computing devices. In embodiments, the client devices 206A and 206B of FIG. 2 each comprise software code including one or more modules. In implementations, these modules are executable by one or more processors to perform method steps according to embodiments of the invention, as described herein. In the example of FIG. 2, client device 206A includes: a display module 220 configured to display digital images to a user, and an interface module 221 enabling the user to interact with a virtual environment provided by the server 204.

FIG. 2 also illustrates a display screen 222 of client device 206A, which displays a digital image of an artwork 224 (object) with areas of interest 230A-230F including features such as a cloud 231 and grass 232. In the example of FIG. 2, the artwork 224 is an object in a virtual environment represented at 225, and a user navigates within the virtual environment 225 and interacts with images of objects therein (e.g., paintings, photographs, sculptures) using navigation tools such as navigation tool 226. Client device 206B may include the same modules as client device 206A, and may also include a display screen for displaying digital images. In the example of FIG. 2, a user of the client device 206A is categorized as a professional viewer Vₚ, and a user of the client device 206B is categorized as an amateur viewer VA.

The server 204 and client devices 206A and 206B may each include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

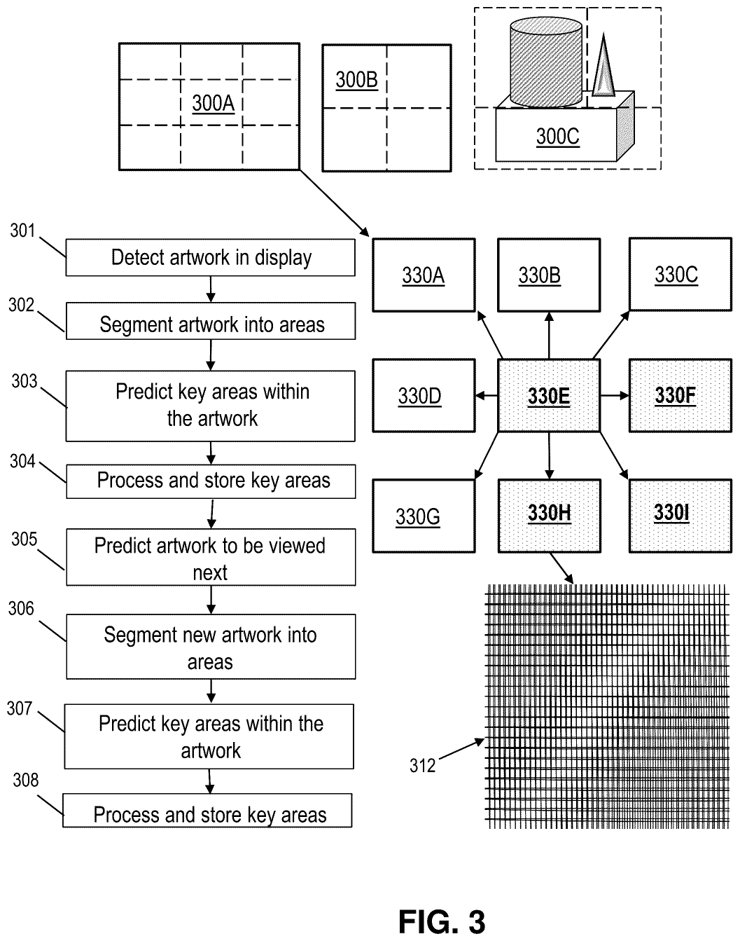

FIG. 3 depicts an overview of a feature prioritization process in accordance with aspects of the invention. The process of FIG. 3 may be implemented in the environment 201 of FIG. 2, and is discussed in reference to elements of FIG. 2.

FIG. 3 shows three exemplary artworks or works of art 300A, 300B and 300C (e.g., paintings, drawings, sculptures or photographs) available for viewing by a user via a GUI provided by the server 204. In accordance with aspects of the invention, at step 301 the server 204 detects that the user is viewing an image of the artwork 300A via the GUI.

At step 302, the server 204 segments the artwork 300A within the image into multiple areas (e.g., feature areas) 330A-330G. At step 303, the server 204 predicts key areas (high priority areas) 330E-330I within the artwork 300A using the trained ML predictive model 215, wherein the key areas are likely to be viewed by the user.

At step 304, the server 204 processes the image data of the key areas 330E-330I to remove moiré patterns (e.g., moiré pattern 312) and other image noise, and saves the processed image data in the buffer 217. Buffer 217 may be a temporary buffer configured to store pre-processed image data prior to display of the image data to a user via the display screen 222 of the user's client device 206A or 206B.

With continued reference to FIG. 3, at step 305, the server 204 predicts a new artwork (e.g., 300B or 300C) most likely to be viewed next by the user. At step 306, the server 204 segments the new artwork into areas (not shown).

At step 307, the server 204 predicts key areas (not shown) within the new artwork using the trained ML predictive model 215. At step 308, the server 204 processes the image data of the key areas of the new artwork to remove moiré patterns and other image noise, and saves the processed image data in the buffer 217.

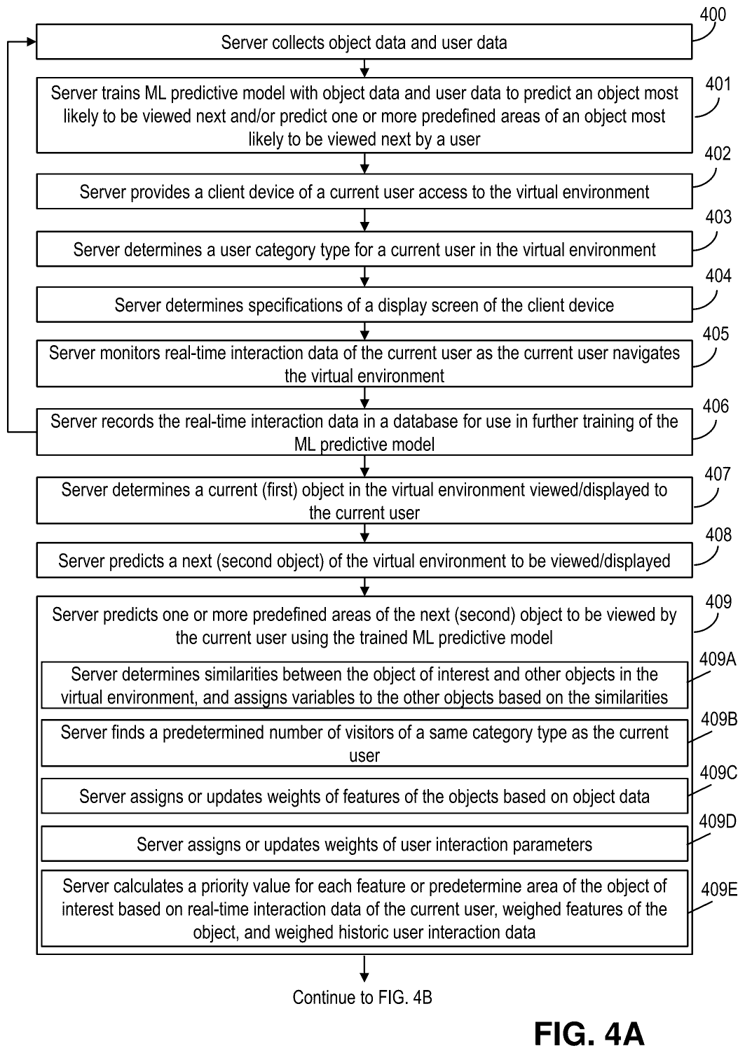

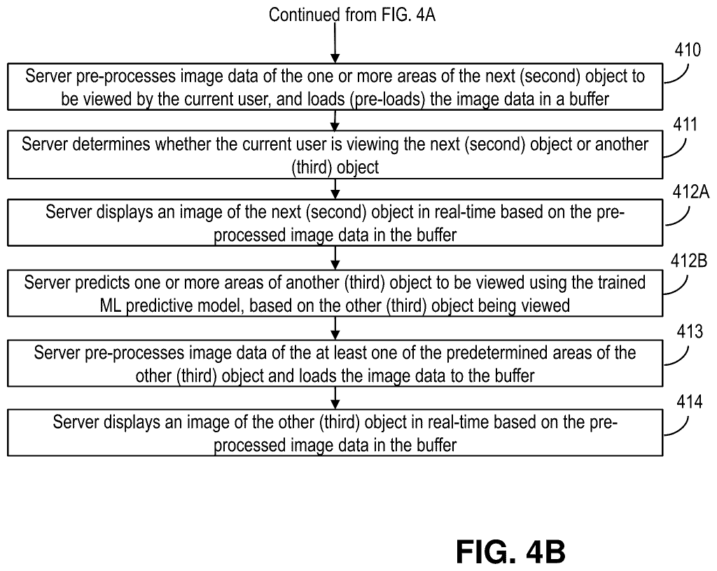

FIGS. 4A and 4B show a flowchart of an exemplary method in accordance with aspects of the present invention. Steps of the method may be carried out in the environment of FIG. 2 and are described with reference to elements depicted in FIG. 2.

At step 400, the server 204 collects object data regarding objects (e.g., artwork 224) displayed within a virtual environment 225 (e.g., a virtual museum, virtual gallery), and user data regarding users of the virtual environment 225. The virtual environment 225 may be an online environment in communication with one or more remote client devices, or an offline virtual environment in communication with one or more auxiliary client devices. The virtual environment 225 may be a two-dimensional or three-dimensional environment. In embodiments, the ML module 214 of the server 204 implements step 400, alone or in conjunction with other modules of the server 204.

User Data

The user data may be collected dynamically in real-time by the server 204 as users engage with the virtual environment 225 via a graphical user interface (GUI) provided by the server 204, and may be stored with time stamp data. In implementations, the user data is collected for a plurality of users of the virtual environment 225, and includes data for categorizing the users, and user interaction data regarding users' interactions with images of objects via the GUI of the virtual environment 225.

In implementations, users (visitors) of the virtual environment 225 are classified as one of two category types: a professional user, or an amateur user. In generally, each category of user will be interested in following different user interaction patterns within the virtual environment 225. For example, an amateur user may only be interested in following a pattern based on a visitor guide, while a professional user may also take into consideration subjective artwork values, an artist or creator's background, etc., which leads to different interaction patterns for the different types of users. In embodiments, data for categorizing the users may include any data indicated in the server 204 as being relevant to a category of user, such as average duration of a user within one or more areas of the virtual environment 225, keywords utilized by a user, a category of a user indicated during a login process, and the location of a user logging into the virtual environment 225 (e.g., university server, government server, etc.). The user data for categorizing the users may overlap with user interaction data.

In implementations, user interaction data includes: navigation data regarding navigation of users through the virtual environment 225; object interaction data regarding users' interactions with images of objects (e.g., artwork 224) within the virtual environment 225, such as zoom-in and zoom-out commands; and other data regarding users' use of user interface tools of the virtual environment 225, such as data collected from the use of a keyword search tool. User interaction data may be based on the virtual environment map 213 of the virtual environment 225, and may indicate relative locations of objects and users within the virtual environment 225. In implementations, the server 204 collects tour routes of a virtual environment (e.g., corresponding to tours given in a physical museum) and visitor traffic data (e.g., a heat map illustrating visitor traffic).

Object Data

In aspects, the object data includes the location (e.g., coordinates) of an object within the virtual environment 225, aesthetic values (e.g., manually assigned or automatically determined) of the objects, characteristics and features of the objects, and background information on creators of the objects (e.g., collected from a database). In embodiments, the server 204 determines features of objects (e.g., aesthetic values, influence, innovation of the artwork, artists' background and characteristics) from literature in a database. In implementations, the server 204 segments each object into a number of predefined areas (e.g., 230A-230F), which include one or more features of the object. Features of an object may be determined by information on aesthetic values, influence, innovation of an artwork, and an artist's background and characteristics, for example. Object information may be collected from: literature in a database (data store 218); analysis of an object (e.g., artwork) itself; and descriptions in a guide to the virtual environment. In embodiments, the server 204 determines or extracts features of objects utilizing image recognition software tools.

At step 401, the server 204 trains, periodically or continuously, the machine learning predictive (ML) model 215 for the virtual environment 425, with object data and user data for a plurality of users, including data for categorizing the users, and user interaction data regarding users' interactions with a graphical user interface (GUI) of the virtual environment. In implementations, for a randomly selected timestamp (Ti), the server 204 records user interaction data for multiple users of different category types and associated objects (e.g., artwork displayed on the GUI at the time of the user behavior data) as input training data. In embodiments, ML predictive model 215 is trained to predict an object most likely to be viewed next by a user, and one or more predefined areas of an object most likely to be viewed next by the user, given their current location within the virtual environment, and their user category type. In embodiments, the ML module 214 implements step 401.

At step 402, the server 204 enables a current user to access the virtual environment 225 (e.g., virtual museum) via their client device 206A or 206B, including navigation tools (e.g., 226) enabling the current user to navigate a virtual two dimensional (2D) or three-dimensional (3D) setting of the virtual environment 225 to view a plurality of objects (e.g., artworks) displayed therein. In embodiments, the server 204 enables access to the virtual environment 225 based on login information of the user and stored user information (e.g., in the user profile module 211). In implementations, the login information indicates to the server 204 a category or type of user. In embodiments, the virtual environment module 212 of the server 204 implements step 405.

At step 403, the server 204 determines a user category type (e.g., professional or amateur) for a current user of the virtual environment (e.g., based on the login information). In embodiments, the user profile module 211 of the server 204 implements step 403.

At step 404, the server 204 determines specifications of a display screen of the client device 206A or 206B of the current user based on display information from the client device 2006A or 206B (from a display module 220). The specifications of a display screen may include, for example: size, resolution, aspect ratio, brightness, viewing angle, or other display information. In embodiments, the user interface module 210 of the server 204 implements step 404.

At step 405, the server 204 monitors real-time interaction data of the current user as the current user navigates the virtual environment 225. In embodiments, the interaction data includes the current user's position within the virtual environment 225, interactions of the current user with one or more objects/artworks (e.g., through user interface tools, such as zoom-in), and a viewing perspective of the current user with respect to one or more objects/artworks in the virtual environment. In embodiments, the virtual environment module 212 of the server 204 implements step 405.

At step 406, the server 204 records the real-time interaction data in a database for use in further training of the trained ML predictive model 215. In implementations, the real-time interaction data is stored with timestamp data. In embodiments, the virtual environment module 212 of the server 204 implements step 406.

At step 407, the server 204 determines a current (first) object (e.g., artwork 224) of the virtual environment 225 viewed/displayed to the current user via the GUI provided by the server 204. For example, the server 204 may determine the current (first) object is shown based on image display data, data from image manipulations tools utilized by the current user, and/or a position of the current user within the virtual environment 225. In embodiments, the virtual environment module 212 of the server 204 implements step 407.

At step 408, the server 204 predicts a next (second) object of the virtual environment 225 to be viewed by the current user. In implementations, the server 204 determines a current position of the user within the virtual environment 225 based on the monitored user interaction data, then determines, based on the virtual environment map 213, objects near and/or adjacent to the current object in a predetermined direction of travel (e.g., a predetermined touring route of a virtual museum or portion of the virtual museum). In implementations, the trained ML predictive model 215 is configured to predict the next (second) object to be viewed by the current user using the current user interaction data, and the category type of the current user, as inputs. In embodiments, the trained ML predictive model 215 predicts the next most likely to be viewed object in the virtual environment 225 based on the category type of the current user and historic user interaction data from users of the same category type. In embodiments, the ML module 214 of the server 204 implements step 408.

At step 409, the server 204 predicts one or more predefined areas of the next (second) object (object of interest) to be viewed by the current user using the trained ML predictive model 215. In implementations, the prediction is based on the user type or category, and information about the next (second) object as data inputs. In embodiments, the server 204 obtains information regarding the next (second) object from a store of object information in the data store 218. In embodiments, the ML module 214 of the server 204 implements step 409. In implementations, step 409 comprises substeps discussed below.

At substep 409A, the server 204 determines similarities (e.g., shared features) between the object of interest and other objects in the virtual environment 225 based on stored object information, and assigns variables to the other objects based on the determined similarities. An example of feature similarities for artworks is set forth in Table 1, discussed below.

At substep 409B, the server 204 finds a predetermined number of N visitors of the same category type as the current user (e.g., N=5 amateur users) in stored historic user interaction data (e.g., in data store 218).

At substep 409C, the server 204 assigns/updates weights applied to predetermined features of the objects based on collected object data. In implementations, the object data is determined from text-based information including: importance of the features derived from literature, and importance of the features derived from an exhibition guide.

At substep 409D, the server 204 assigns/updates weights applied to user interaction parameters. User interaction parameters may include, for example, zoom-in, zoom-out, dwell time of a user on an image or portion of the image, etc. In implementations, the weights are determined based on similarities between the historic (reference) user and the current (target) user based on the real-time interaction data of the current user and the historic user interaction data.

At substep 409E, the server 204 calculates a priority number or rating for each feature or predefined area of interest (containing one or more features) of the object of interest based on the real-time interaction data of the current user, weighted features of the object, and weighted historic user interaction data.

Examples of the assignment of features and the prediction of areas of objects most likely to be viewed by a current user are set forth in Table 1 and Table 2 below.

TABLE 1
Similarity of Artworks

| | USER 1 | USER 2 | USER 3 | USER 4 | USER 5 |
|---|---|---|---|---|---|
| ARTWORK 1 | {Feature 1, | 0 | {Feature 1, | 0 | {Feature 1, |
| | Feature 2, . . . | | Feature 2, . . . | | Feature 2, . . . |
| | Feature k} | | Feature k} | | Feature k} |
| ARTWORK 2 | 0 | {Feature 1, | 0 | {Feature 1, | 0 |
| | | Feature 2, . . . | | Feature 2, . . . | |
| | | Feature k} | | Feature k} | |
| . . . | . . . | . . . | . . . | . . . | . . . |
| ARTWORK U | {Feature 1, | {Feature 1, | {Feature 1, | {Feature 1, | {Feature 1, |
| | Feature 2, . . . | Feature 2, . . . | Feature 2, . . . | Feature 2, . . . | Feature 2, . . . |
| | Feature k} | Feature k} | Feature k} | Feature k} | Feature k} |

With reference to Table 1, the sever 204 may predict areas of a target artwork likely to be viewed or interacted with by a current user by: (1) finding similar artworks to the target artwork and recording the similarities between the similar artworks and the target artwork using the variables S1, S2, S3, etc.; (2) finding N visitors of the same type as the current user, assuming N=5; (3) extracting the features most viewed or interacted with from the similar artworks by the visitors of the same type as the current user for the same virtual environment 225. In implementations, the server 204 maps features of each artwork using image recognition techniques.

TABLE 2
Prioritization of Features

| | FEATURE 1 | FEATURE 2 | FEATURE 3 | . . . | FEATURE K |
|---|---|---|---|---|---|
| ARTWORK 1 | [P(f1) + E(f1) + | [P(f2) + E(f2) + | [P(f3) + E(f3) + | . . . | [P(fk) + E(fk) + |
| | Sim1 + | Sim1 + Sim | Sim 3] * S1 | | Sim1 + sim |
| | Sim3] * S1 | 5] * S1 | | | 3 + Sim 5] * S1 |
| ARTWORK 2 | [P(f1) + E(f1) + | [P(f2) + E(f2) + | [P(f3) + E(f3) + | . . . | [P(fk) + E(fk) + |
| | 0]*S2 | Sim2 + | 0] * S2 | | Sim 4] * S2 |
| | | Sim4] * S2 | | | |
| . . . | . . . | . . . | . . . | . . . | . . . |
| ARTWORK U | [P(f1) + E(f1) + | [P(f2) + E(f2) + | [P(f3) + E(f3) + | | [P(fk) + E(fk) + |
| | Sim 1 + Sim | Sim 2 + Sim 3 + | Sim 4 + sim | | 0] * Su |
| | 2 + Sim 3) * Su | Sim 4] * Su | 5] * Su | | |

In the example of Table 2, database cells are populated with a set of features of the artworks, wherein the features are reflected in mapping areas of each of the artworks. The server 204 assigns each feature of an artwork a weight based on: (1) a determined importance of the feature derived from literature, represented by P(fn), wherein for amateur visitors, P=0; (2) a determined importance of the feature derived from an exhibition guide, represented by E(fn); and (3) a determined similarity between the reference (historic) visitor and the target visitor (current user), while real data is being collected. In the example of Table 2, where a User 1 and the target user have both viewed Artwork 1, the similarity is calculated as Sim1. In contrast, where User 2 did not view Artwork 2 while the target user did view Artwork 2, the similarity is calculated as 0. It can be understood that, based on the priority value calculated for each feature within the target artwork, the server 204 can know the priority of the predefined mapping areas of the target artwork, and can optimize the image data (by image processing) for highest priority areas (e.g., those areas having a priority value meeting a threshold value) in advance of a user viewing those features.

With reference to FIG. 4B, at step 410, the server 204 pre-processes image data of at least one of the predefined areas of the next (second) object for storage in a buffer, based on the prediction (priority numbers or ratings), and in response to the predicting that the next (second) object will be viewed next by the current user. In implementations, the pre-processed image data is stored or pre-loaded in the buffer 217, and improves the viewing quality of the processed image data. In embodiments, step 410 occurs before any interaction of the current user with the next (second) object (e.g., prior to display of the next (second) object to the current user). In embodiments, the pre-processing of the image data comprising one or more image processing methods to remove any real or anticipated moiré pattern, reduce noise, and implement de-aliasing. It should be understood that various image processing tools and methods may be utilized to implement step 410, and embodiments of the invention are not intended to be limited to any particular tools or methods. In embodiments, the imaging module 216 of the server 204 implements step 410.

At step 411, the server 204 determines whether the current user is viewing the next (second) object or a different object in the virtual environment 225 based on the real-time interaction data of the current user and the virtual environment map 213. In embodiments, the virtual environment module 212 of the server 204 implements step 411.

At step 412A, if the server 204 determines that the current user is viewing the next (second) object, the server 204 displays an image of the next (second) object to the current user in real-time based on the pre-loaded/pre-processed image data in the buffer. In embodiments, the user interface module 210 of the server 204 implements step 412A.

In contrast, at step 412B, if the server 204 determines that the current user is viewing another (third) object instead of the next (second) object, the server 204 predicts one or more areas of the other (third) object (object of interest) to be viewed by the current user using the trained ML predictive model 215, based on the user type or category, and information about the other (third) object as data inputs. In implementations, the server 204 obtains information regarding the other (third) object from a store of object information in the data store 218. In embodiments, the ML module 214 of the server 204 implements step 412B. Step 412B may be performed using substeps 409A-409E described above.

At step 413, the server 204 pre-processes image data of at least one of the predefined areas of the other (third) object for storage in a buffer, based on the prediction (e.g., priority numbers or ratings) of step 412B, and loads the pre-processed image data to the buffer. In embodiments, the pre-processing of the image data comprising one or more image processing methods to remove any moiré pattern, reduce noise, and implement de-aliasing. In embodiments, the imaging module 216 of the server 204 implements step 413.

At step 414, if the server 204 displays an image of the other (third) object to the current user in real-time based on the pre-processed image data in the buffer. In embodiments, the user interface module 210 of the server 204 implements step 414. It can be understood that steps of FIGS. 4A and 4B may repeat as a current user navigates through and interacts with the virtual environment 225.

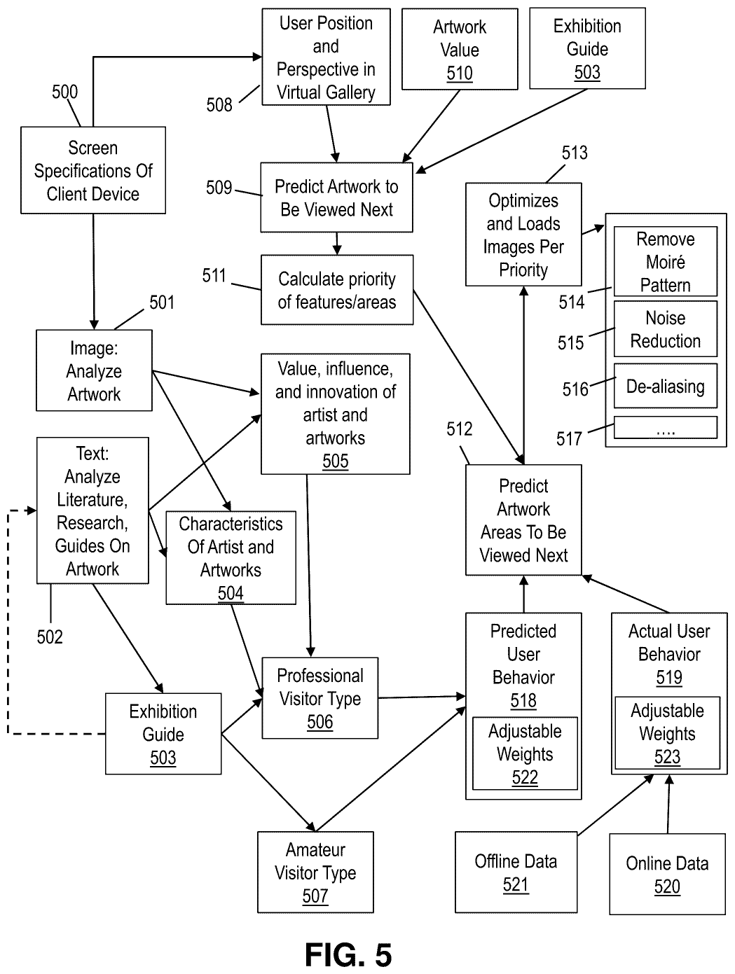

FIG. 5 shows a data flow diagram in accordance with aspects of the invention. Steps shown in FIG. 5 may be carried out in the environment of FIG. 2 and are described with reference to elements depicted in FIG. 2.

In embodiments, a system for learned image feature prioritization utilizes input parameters of: screen specifications of a client device of a user; tour routes of a virtual environment (e.g., virtual gallery) determined or derived from a guide to the environment (e.g., an exhibition guide for a physical museum upon which the virtual environment is based); location and viewing perspective of the user in the virtual environment; features of objects (artworks) in the virtual environment; and user category or type (e.g., professional visitor or amateur visitor). In the example of FIG. 5, the virtual environment is a virtual gallery, and the objects comprise works of art, which may be pictures, paintings, sculptures or other works of art.

At 500, the server 204 obtains the screen specifications from a client device 206A or 206B, according to step 404 of FIG. 4A.

At 501, the server 204 analyzes images of artwork within the virtual gallery using digital image analysis tools and methods to obtain object information about features of the artwork, in according to step 400 of FIG. 4A.

At 502, the server 204 obtains additional information regarding the artwork by analyzing text-based documents such as literature, research results, and guides on the artwork using natural language processing (NLP) or other text recognition tools, in accordance with step 400 of FIG. 4A. In implementations, the text-based documents may be documents available to visitors of a real physical gallery on which the virtual gallery is based. In the example of FIG. 5, the analysis at step 503 includes the analysis of descriptions of artworks in an exhibition guide 503. In aspects, the analysis of step 502 determines or derives information including characteristics of artists and artworks 504; and value, influence and innovation of artists and artworks 505.

In implementations, the server 204 access a corpus of gathered information for users/visitors of a professional type 506, including: information from the exhibition guide 503; characteristics of artists and artworks 504; and value, influence and innovation of artists and artworks 505. In embodiments, the server 204 accesses information from the exhibition guide 503 only, for users/visitors of an amateur type 507.

In accordance with step 405 of FIG. 4A, as a user navigates through the virtual gallery, the server 204 gathers user interaction data based on the user's activities within the virtual gallery, including the user's position and perspective in the virtual gallery, as indicated at 508.

At 509, the server 204 predicts a next artwork to be viewed by the user based on the user position and perspective in the virtual gallery 508, stored determined artwork values 510, and the exhibition guide 503, according to step 408 of FIG. 4A. In implementations, the server 204 utilizes the trained ML predictive model 215 to predict the next artwork to be viewed.

Based on determining a next artwork to be viewed, the server 204 calculates the priority of features or predefined areas of the next artwork at 511, in accordance with step 409 of FIG. 4A. Once the server 204 calculates the priority of features of the next artwork, the server 204 predicts at 512 which of the one or more predefined areas of the next artwork (e.g., containing the prioritized features) the user is likely to view next using the trained ML model 215, in accordance with step 409 of FIG. 4A. In implementations, the prediction at 512 is based on predicted user behavior 518 determined from historic user interaction data for either a professional type of user/visitor 506 or an amateur type of user/visitor 507. In embodiments, the prediction 512 is further based on the actual behavior of the user/visitor 519 determined from real-time online user interaction data 520 (e.g., data regarding web page stay and a heat map of user interactions within the virtual gallery), and/or offline information 521 (e.g., determined focus time and perspective of the user).

Based on the priority of the features, the server 204 optimizes and loads images of the predefined areas of the next artwork containing the highest priority features (based on a threshold value) at 513, in accordance with step 410 of FIG. 4B. In the example of FIG. 5, the optimization of the image at 513 includes removing a moiré pattern at 514 that has or would occur due to the screen specification of the client device and a digital image of a feature of the next artwork. The optimization of images at 513 further includes noise reduction at 515, de-aliasing at 516, and any other image processing method that would improve the quality of the viewing experience of a user, as represented at 517.

In implementations, the server 204 periodically or dynamically adjusts weights 522 applied to different predicted user behavior parameters and weights 523 applied to actual user behavior parameters based on new or updated information regarding: a determined importance of the features, and/or similarity between the user/visitor and historic visitors (e.g., similarities between user interaction data of the user/visitor and the user interaction data of the historic visitors of the same type).

An exemplary use scenario will now be discussed with reference back to FIG. 2. Zoe is an oil painting student who likes visiting art exhibitions and appreciates the work of master artists. Zoe's access to physical art galleries and museums is limited, but she has had bad online experience with virtual exhibitions due to the frequent moiré patterns that prevented a viewer from observing the details of an artwork clearly. Recently, an exhibition of Zoe's favorite painter was hosted online. Zoe logged into a virtual gallery hosted by the server 204 via the client device 206A, selected “professional audience” as her identity type, then entered the virtual gallery to experience the online exhibition. At the beginning, Zoe approached a first painting 224 in a first section of the virtual gallery 225. The server 204 predicted that the first painting 224 will be the first painting viewed by a user/visitor of a “professional audience” type. Zoe learned that paintings of the artist have a high appreciation value due to the use of distinct brush strokes depicting changes of light and the presentation of colors. After gazing at the painting 224 for a while, she zoomed in on part of the cloud 231 in a predefined middle section 230B of the painting to observe thick brush strokes and how the light influences the light and darkness of the cloud 231. Then her perspective was moved to the bottom section, and she zoomed in on grass 232 in another predefined section 230E to observe the mixed colors of the grass 232.

After looking at the first painting 224 in detail, she navigated, using a navigation tool (e.g., tool 226) of the virtual gallery 225, to focus on a second painting (not shown) located within the virtual gallery 225 on the right side of the first painting 224. Zoe found that the whole online viewing experience was much improved over previous online viewing experiences, since the viewing process was very smooth without any lag, especially when zooming in to view details of the paintings. In addition, there were no negative visual effects, such as moiré patterns, high noise and aliasing because the server 204 divided the viewing area of each painting, analyzed both the painting itself and the textual materials such as professional or official guides related to the painting, combined with the historical data of other previous user behaviors. The server 204 then generated suggested viewing points (e.g., 230B and 230E) which predicted the details (e.g., 231 and 232) that users are possibly interested in for each painting, calculated the priority of suggested viewing points, and optimized the images of those viewing points in advance according to the priority. In this scenario, Zoe's actual viewing order matched the system's prediction, so the system accurately pre-processed image data of each painting and corresponding details before Zoe observed them, which enhanced Zoe's exhibition experience.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
providing a client device access, by a computing device, to a virtual environment via a graphical user interface (GUI), the virtual environment including images of objects and a user navigation tool enabling a user to navigate the virtual environment and interact with the images of the objects;
monitoring and recording, by the computing device, real-time interaction data of the user indicating navigation of the user through the virtual environment and interactions of the user with the images;
calculating, by the computing device, priority values for predefined areas of a first object of the objects in the virtual environment, using a machine learning (ML) model trained with historic user interaction data and object data;
processing, by the computing device, digital image data of one or more of the predefined areas of the first object using image processing to generate new digital image data based on display specifications of the client device and the priority values; and
pre-loading, by the computing device, the new digital image data in a buffer, such that the new digital image data is available to the computing device prior to display of the new digital image data to the user via the GUI.

2. The method of claim 1, further comprising: predicting, by the computing device, a next object to be viewed by the user in the virtual environment is the first object, based on the real-time interaction data.

3. The method of claim 1, further comprising: determining, by the computing device, features of the first object by processing text-based information of the first object using natural language processing.

4. The method of claim 1, further comprising: training, by the computing device, the ML model periodically or continuously using the real-time interaction data of the user as training data.

5. The method of claim 1, further comprising: determining, by the computing device, a category type of the user, wherein the calculating the priority values for the predefined areas of the first object is based on the category type of the user.

6. The method of claim 1, wherein the digital image data causes a moiré pattern on a display of the client device, and the processing the digital image data removes the moiré pattern.

7. A computer program product comprising one or more computer readable storage media having program instructions collectively stored on the one or more computer readable storage media, the program instructions executable to:
provide a remote client device access to a virtual environment via a graphical user interface (GUI), the virtual environment including images of artworks and at least one user navigation tool enabling a user to navigate the virtual environment and interact with the images of the artworks;
monitor and record real-time interaction data of the user indicating navigation of the user through the virtual environment and interactions of the user with the images;
determine a user category type of the user;
determine display specifications of the client device;
calculate priority values for predefined features of a first artwork in the virtual environment based on the user category type of the user, using a machine learning (ML) model trained with historic user interaction data and data about the first artwork;
process digital image data of one or more of the predefined features of the first artwork using image processing to generate new digital image data based on the display specifications of the client device and the priority values; and
pre-load the new digital image data in a buffer, such that the new digital image data is available prior to display of the new digital image data to the user via the GUI.

8. The computer program product of claim 7, wherein the program instructions are further executable to: predict a next artwork to be viewed by the user in the virtual environment is the first artwork, based on the real-time interaction data and the ML model.

9. The computer program product of claim 7, wherein the program instructions are further executable to: train the ML model periodically or continuously using the real-time interaction data of the user as training data.

10. The computer program product of claim 7, wherein the digital image data causes a moiré pattern on a display of the client device, and the processing the digital image data removes the moiré pattern.

11. The computer program product of claim 7, wherein the program instructions are further executable to:
determine similarities of features of the first artwork and features of other artworks in the virtual environment; and
determine similarities between the historic user interaction data of users of the same user category type as the user, and the real-time interaction data of the user, wherein the calculating the priority values for the predefined features of the first artwork in the virtual environment is further based on the determined similarities of the features and the determined similarities between the historic user interaction data of the users and the real-time user interaction data of the user.

12. The computer program product of claim 11, wherein the program instructions are further executable to: determine the features of the first artwork by processing text-based information of the first artwork using natural language processing.

13. The computer program product of claim 11, wherein the features are weighted based on an importance of the features derived from text-based literature.

14. A system comprising:
a processor set, one or more computer readable storage media, and program instructions collectively stored on the one or more computer readable storage media, the program instructions executable to:
provide a remote client device access to a virtual environment via a graphical user interface (GUI), the virtual environment including images of artworks and at least one user navigation tool enabling a user to navigate the virtual environment and interact with the images of the artworks;
monitor and record real-time interaction data of the user indicating navigation of the user through the virtual environment and interactions of the user with the images;
determine a user category type of the user;
determine specifications of a display screen of the client device;
calculate priority values for predefined features of a first artwork in the virtual environment based on the user category type of the user, using a machine learning (ML) model trained with historic user interaction data and data about the first artwork;
process digital image data of one or more of the predefined features of the first artwork using image processing to generate new digital image data having a higher viewing quality on the display of the client device than the digital image data, based on the display specifications of the client device and the priority values;
pre-load the new digital image data in a buffer; and
display an image of the first artwork on the display screen of the client device via the GUI based on the pre-loaded new digital image data.

15. The system of claim 14, wherein the program instructions are further executable to: predict a next artwork to be viewed by the user in the virtual environment is the first artwork, based on the real-time interaction data using the ML model.

16. The system of claim 14, wherein the program instructions are further executable to: train the ML model periodically or continuously using the real-time interaction data of the user as training data.

17. The system of claim 16, wherein the digital image data causes a moiré pattern on the display of the client device, and the processing the digital image data removes the moiré pattern.

18. The system of claim 14, wherein the program instructions are further executable to:
determine similarities of features of the first artwork and features of other artworks in the virtual environment; and
determine similarities between the historic user interaction data of users of the same user category type as the user, and the real-time interaction data of the user, wherein the calculating the priority values for the predefined features of the first artwork in the virtual environment is further based on the determined similarities of the features and the determined similarities between the historic user interaction data of the users and the real-time user interaction data of the user.

19. The system of claim 14, wherein the program instructions are further executable to: determine the features of the first artwork by processing text-based information of the first artwork using natural language processing.

20. The system of claim 19, wherein the features are weighted based on an importance of the features derived from the text-based information.
